(19) United States
(12) Patent Application Publication
(10) Pub. No.: US 2010/0224102 A1
(43) Pub. Date: Sep. 9, 2010

(54) Integrated Foam Vehicle Tray Table Assembly

(76) Inventor: Philip A. Allgood, Atlanta, GA (US)

Correspondence Address: Talbot Parker Thrasher, 11010 Ramblewood Drive Apt #3, Cumberland, MD, 21502, US

(21) Appl. No.: 12/399,272

(22) Filed: Mar. 6, 2009

(51) Int. Cl. A47B 37/00; B29C 65/02; B60N 3/00

(52) U.S. Cl. 108/44; 264/46.5

(57) ABSTRACT

In one embodiment, a system and method for the production for a vehicle tray table employing foam in place sandwich structure, whereas the encapsulated foam is employed as a labor, cost and weight saving material to bond and affix the tray table assembly components.

### BACKGROUND

1. Field of the Invention

The present disclosure generally relates to tray tables attached to vehicle seats as a support surface for writing, dining or other activities More particularly, the present disclosure relates to the methods for fabricating a seatback tray table assembly for use in vehicles.

2. Description of the Related Art

Most seat configurations for multiple passenger vehicles such as trains, airplanes and buses, have a tray table for the passenger that is located on the back of the seat assembly located in front of the seat occupant. The seat back will most likely possess a deployable tray table with a surface for eating, working, writing or other such uses to the passenger. These tray tables have been made in the past from progressively lighter or stronger materials and designs to save weight and thus improve efficiency of the overall vehicle fuel consumption. The cost and ease of fabrication of the tables has improved dramatically over the years. The current state of the art tray table is a foam core that provides the shear and structural medium of a sandwich structure, structurally bonded to an upper and lower plastic skin using film or liquid adhesive. Guide tubes, metal structures, hinges and other components are inserted inside the tray table as a means for attaching the tray table to the seat and allowing it to extend in a cantilevered position for use. These guide tubes (also know as sliders) are normally rectangular tube sections (though square, round and oval cross sections are not novel) that slide onto a connecting rod, hinge side, or other extending arm, which is the tray table holding device affixed to the seat back in front of the passenger. The guide tubes may also be replaced by solid rods, a single tube, hinge attachments or other means for external attachment, with features, in some configurations, where attachment methods differ from the means employed in most current designs.

### SUMMARY

Typically, a tray table is manufactured by initially producing a generic or shaped pre-cast foam part roughly simulating the interior area of the tray table. An adhesive is then applied to inside of the top and bottom plastic covers. The foam, guide tubes, and other additional components if needed, are placed inside the lower cover, the top cover is placed on and then the assembly presses together to bond the structure. The periphery then may be sealed with a solvent bond process.

The novelty of the disclosed method of fabrication provides for the elimination of the adhesive liquid or film, foam shaping, custom fitting process and the associated labor employed during the assembly process. This is accomplished by placing the components inside the plastic covers and using a foam-in-place medium and allowing the foam to expand and cure while in a temperature controlled and pressurized fixture. The foam in the cavity will cure to a desired hardness and provide dimensional stability for the assembly and the components inside. This process allows for the foam to conform intimately to the components and structurally bond directly to a predominant area of the inside surface covers, eliminating the need for and the associated weight and cost of a secondary adhesive for structural rigidity. This method results in a tray table that is light, requires less labor, and improves the manufacturing process by a simplification and reduction of the assembly steps. The foam density can also be further refined or reduced, and thus potentially eliminate even more weight, by simply reducing the amount of foam mixture poured into the cavity or processing temperature. This is contrary to the state of the art wherein industry standard foam densities are currently used and have relatively large steps between available foam densities. The assembly can also be post cured, a process where the assembly is placed at an elevated temperature to further complete the chemical reaction of the foam chemistry.

By allowing for specific tailoring of foam density, providing a conformable foam medium, and eliminating the structural adhesive, a superior tray table is produced.

The method for making the tray table excludes the primary use of an additional adhesive for the purpose of bonding the internal components of to the tray table covers for structural rigidity. This is accomplished by proper preparation of the skins for foam in place sandwich medium in a contained fixture to pressurize the foam during processing resulting in the necessary integral bonding of the assembly. Thus the foam in place medium is used not only for bonding the covers to make a sandwich structure, but also integrating the foam and foaming process as a locating and bonding material and method for the components and the covers of the tray table assembly.

Further objects, features and advantages of the invention will become apparent from a consideration of the following description and the appended claims when taken in connection with the accompanying drawings.

### BRIEF DESCRIPTION OF THE DRAWINGS

The disclosed tray table system and methods and method for fabrication can be better understood with reference to the following drawings. The components in the drawings are not necessarily to scale.

FIG. 1 is a view of a tray table connected to a vehicle seat.

FIG. 2A-B are views of the assembled and unassembled components of a tray table without foam.

FIG. 3A-D are views of edge sealing methods.

FIG. 4 is a view of the foam cream mixture being poured into the lower cover.

FIG. 5A-C are views of the assembly of the tray table during the foaming process being loaded into a press for curing of the foam.

FIG. 6A and FIG. 6B are cross sections of an assembled tray table including the foam.

### DETAILED DESCRIPTION

As described in the foregoing, it is difficult to produce a lightweight tray table without adhesive liquid or film as the primary bonding component using foam in place material. Previous efforts have been unable to create sufficient bond strength, contain the foam, or produce a homogenous foam density without excess entrapped gases and provide a resulting tray table that will withstand a service environment.

Described in the following is a system and method for manufacturing a lightweight structural seatback tray table. Although specific embodiments are presented, those embodiments are mere example implementations and it is noted that other embodiments are possible. All such embodiments are intended to fall within the scope of this disclosure.

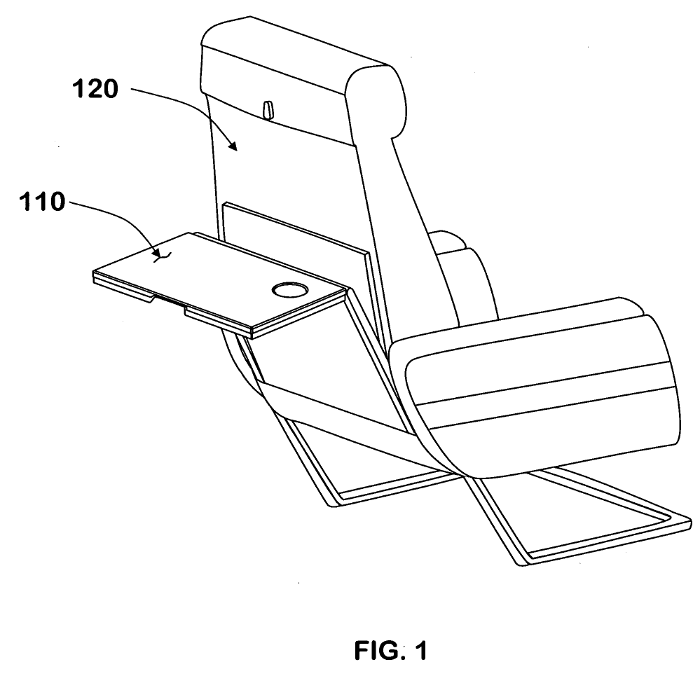

Turning to the figures, in which like numerals identify corresponding components, FIG. 1 illustrates an embodiment of the tray table assembly 110 attached to the back of a vehicle seat 120.

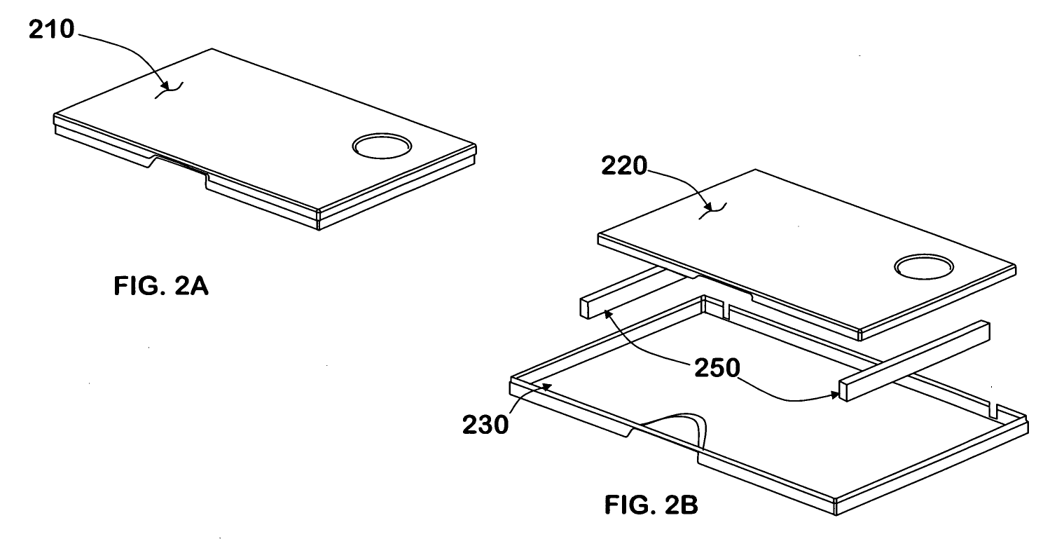

FIG. 2A-B illustrates an embodiment of the tray table assembly 210 and the minimum components necessary for assembly. The tray table assembly 210 is comprised by a lower cover 230 (or skin) and an upper cover 220. These covers fit together to encapsulate a cavity which will contain the foam core material and a means for mechanical attachment, in this view there are two guide tubes 250. The inner surface of these covers must be cleaned and prepared for bonding. This requires lightly abrading the internal cover surface with a scuffing pad or sandpaper like substance, flame treatment or other similar methods to create a physical or chemical propensity to bond and may further include cleaning with a solvent wipe. The means for attaching must be sealed to the internal cavity if they are hollow, however it may have an opening to allow the connecting rod, hinges or other connecting means to slide inside the means for attaching at the point of attachment. The means for attaching must be sealed, other than this open end, to eliminate foam from entering the inner part of the tube during the foaming process.

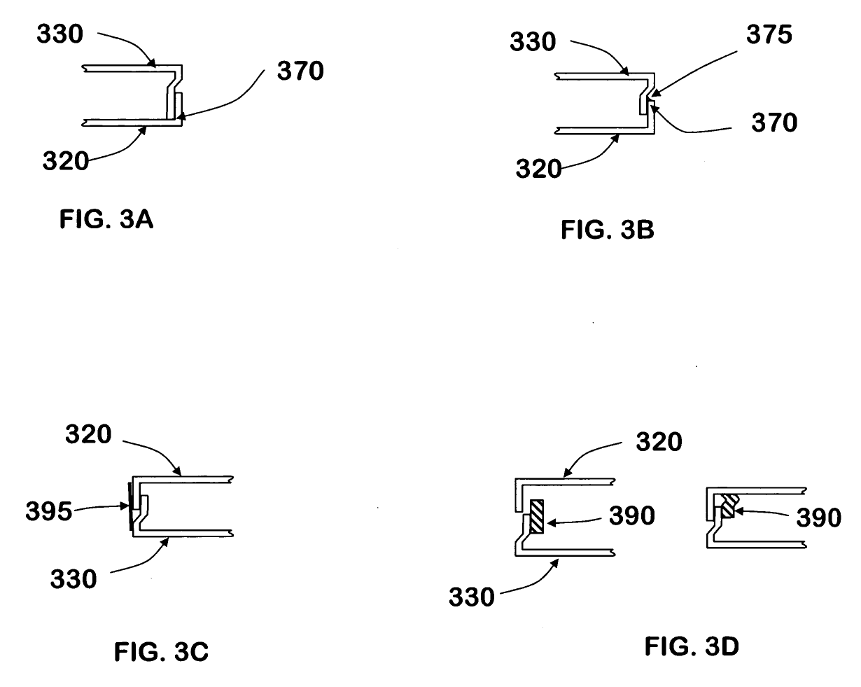

This process requires that the edges of the cavity formed by the top cover 330 and the bottom cover 320 are sealed to contain the foam from blowing out of the mold through the seams between the covers and the openings of the guide tubes or other means for attaching. Although a perfectly trimmed pair of covers can seal intimately 370, as in FIG. 3A, and may not need an additional sealing method beyond the contacting perimeter of the covers. But multiple alternate methods for sealing the edges are envisioned. Examples of these methods include, but are not limited to solvent bonds, tape sealant and foam sealants.

FIG. 3B depicts the location and effect of sealing of the cover edges accomplished by a solvent bond. This process uses a solvent, such as Tetrahydrofuran (THF), applied to the contact point 370 of the upper cover 320 and the lower cover 330 to effectively melt the plastic covers and join them when the solvent evaporates and leaves a plastic meniscus 375 at the contact point. This method is most difficult as it must be performed after pouring in the foam.

FIG. 3C depicts the application of a removable tape (or any conformable and removable outer seal) 395 on the outside of the seam of the covers. It is necessary and difficult to press the tape into the cavity between the covers to produce an aesthetically pleasing final part, and as such this is not the preferred method as it also must be performed after pouring in the foam.

The preferred method shown in FIG. 3D employs a foam tape with pressure sensitive adhesive 390 applied to the inner cover (in the configuration as viewed this is the lower cover 330, inner being defined as the cover with the edge residing in the internal cavity of the final assembly). The foam tape 390 is attached, protruding high enough above the edge of the cover such that when the opposing cover 320 is placed on top and the assembly is pressed into the molding fixture, the foam tape 390 will compress an create a seal for the cavity edge, thus preventing blow out during the structural foam expansion. The seal is made after the foam is poured into the lower cover 330 and when the upper cover is placed on top.

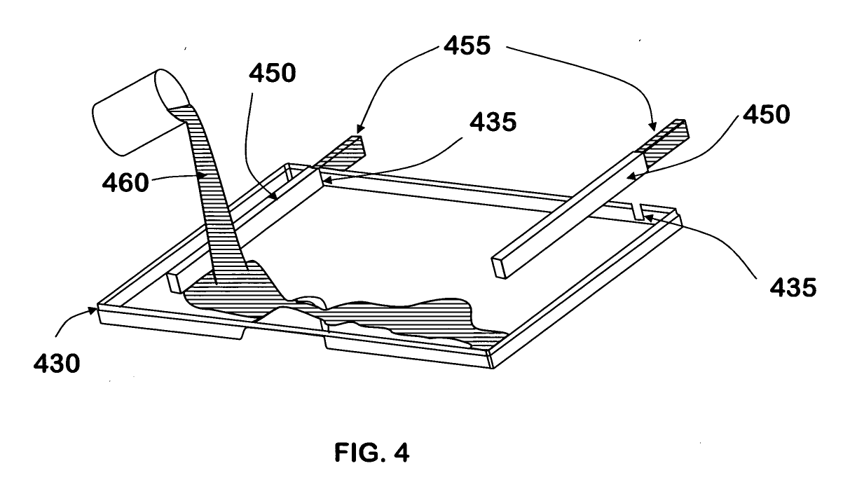

FIG. 4 illustrates the preparation and locations of the components of the assembly for the foam installation. Guide tubes 450, representing a means for attaching, are placed onto the fixture positioning rods 455 (or other appropriate mechanical means) and fitted into the lower cover cutout slot 435 for accurate positioning during the curing process. A measured amount of at least 2 part mixture of foam resin and catalyst is mixed together into a creamy liquid. The measured amount is determined by the size of the cavity, the predicted post expansion volume of the foam and the foam's desired density. This pre-foam liquid is called a foam cream 460. This foam cream will rapidly catalyze and the foaming agents in the mixture will create tiny gas bubbles in the resin liquid and create a visco-elastic foam which will rapidly expand into the cavity formed by the covers. The catalyst in the mixture will cure the resin into a single piece of rigid foam. The cream is poured along the edge of a preheated lower cover 430 (as defined by gravity for pouring) at the side opposite the lower cover cutout slots 435. This allows for the foam to expand and push the entrapped air in the cavity out of the small gap between the lower cover cutout slots 435 and the guide tubes 450.

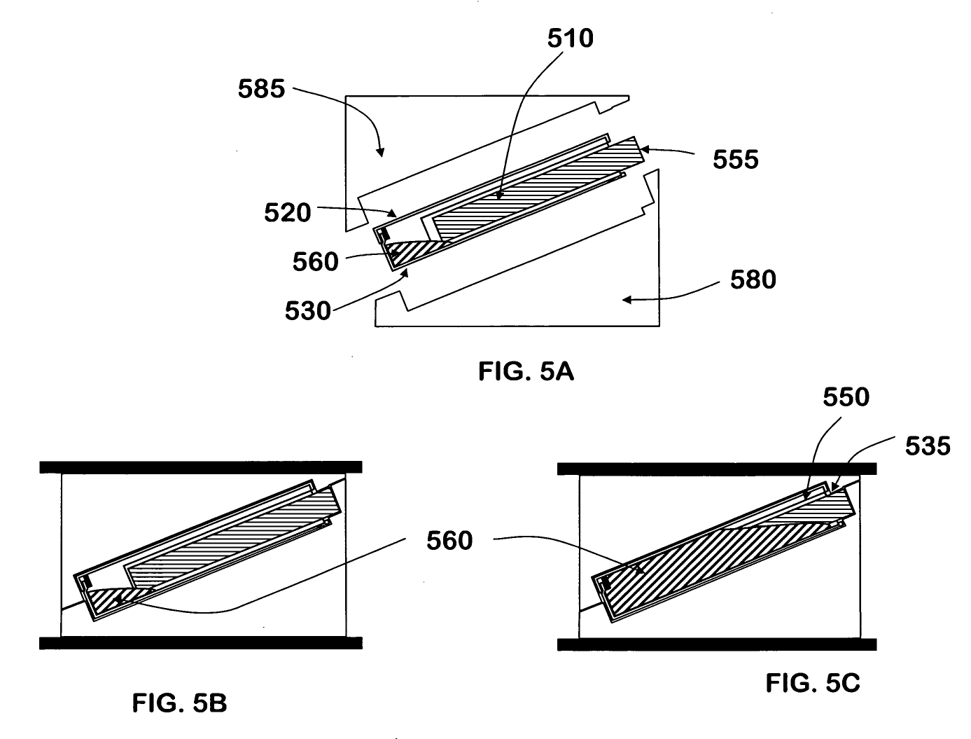

FIG. 5A illustrates the assembly 510 after the cream 560 is poured into the lower cover 530, a preheated upper cover 520 is placed onto the lower cover and the assembly 510 is placed into a lower press fixture 580 such that the fixture positioning rods 555 are located into a designated position in the lower press fixture 580. This fixture also has an upper section 585, and both are shaped with an interior profile to support shape of the tray table assembly as the foam expands and cures. The cavity of the fixture is angled at least 10 degrees from horizontal, preferably 20 degrees, to assist in the foam filling the cavity from the bottom, using gravity, to push air, entrapped in the cavity that is not filled or being filled by the foam, out of the small gap between the lower cover cutout slots 535 and the guide tubes 550. The fixtures are pre-heated to the proper foam cure temperature and a pressure of at least 350 Kpa (51 PSI) is employed to contain the outer surfaces of the assembly 510. The upper 585 and lower 580 fixtures are not required to be at the same temperature. For ease of manufacturing and thermal control simplification, the temperatures may differ. FIG. 5B and FIG. 5C highlight the expanding foam 560 filling the internal cavity of the tray table. The foam cream expands and creates a hydrostatic pressure which not only fills the internal cavity but bonds to a preponderance of the internal cover surfaces creating a sandwich structure.

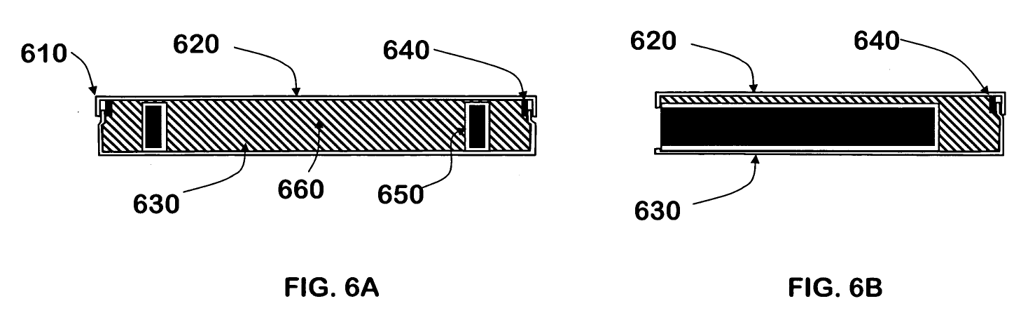

FIG. 6A and FIG. 6B illustrate a front and side cross section view of a completed tray table assembly 610. The upper cover 620 is now bonded to the lower cover 630 by the cured foam 660. The guide tubes 650 are now permanently located for attachment and the integrated seal 340 is encapsulated in the cavity.

It is to be appreciated, however, that the concepts described in the following can be applied to substantially any vehicle tray table that requires a lightweight integrated assembly method; however, other tray tables aesthetic curves, thickness variations and configurations as well as guide tube shapes configurations are contemplated.

The following are claimed:

1. A method for fabricating a vehicle tray table assembly, the method comprising:
Where an assembly, comprised of foam cream that is placed inside a lower plastic cover; and
at least one means for external mechanical attachment is placed inside said lower cover, wherein at least one means for external mechanical attachment is located and fixed in the cavity; and
an upper plastic cover, where the upper cover is placed on top of the lower cover to envelope a cavity; and
Wherein the assembly is placed into a heated mold fixture at an angle of at least 10 degrees and pressure is applied to the fixture to maintain the external dimensions of the tray table assembly during the creams transition to cured foam, to bond the assembly together.

2. The method of claim 1, wherein the assembly is post-cured.

3. A vehicle tray table assembly system comprising;
an upper plastic cover;
a lower plastic cover;
an internal cavity between the upper and lower cover;
at least one means for external mechanical attachment;
a foam core material that has expanded in place to occupy the internal cavity;
wherein a sandwich structure is created by the foam core material that is structurally bonded to a preponderance of and in direct intimate contact with the means for external mechanical attachment, the upper cover and the lower cover.
